(19) United States
(12) Patent Application Publication
(10) Pub. No.: US 2019/0186590 A1
(43) Pub. Date: Jun. 20, 2019

(54) DAMPER DEVICE

(71) Applicant: TOYOTA JIDOSHA KABUSHIKI KAISHA, Toyota-shi (JP)

(72) Inventors: Tsutomu Yabashi, Nagoya-shi (JP); Toru Hiranuma, Miyoshi-shi (JP)

(73) Assignee: TOYOTA JIDOSHA KABUSHIKI KAISHA, Toyota-shi (JP)

(21) Appl. No.: 16/208,613

(22) Filed: Dec. 4, 2018

(30) Foreign Application Priority Data
Dec. 15, 2017 (JP) 2017-241034

(51) Int. Cl. F16F 15/123; F16F 15/129

(52) U.S. Cl. CPC F16F 15/12353; B60Y 2400/48; F16F 2232/02; F16F 15/129

(57) ABSTRACT

A damper device includes a first damper and a behavior limiter. The first damper includes a base and a first mass body. The base is mounted on a rotary shaft member and configured to rotate together with the rotary shaft member, and the first mass body is provided at the base via a first elastic part. The behavior limiter is disposed around the first mass body on the outside in a rotation radial direction of the first mass body, and limits a movement of the first mass body by coming into contact with the first mass body when a rotational frequency of the rotary shaft member has become equal to or higher than a threshold value.

### INCORPORATION BY REFERENCE

The disclosure of Japanese Patent Application No. 2017-241034 filed on Dec. 15, 2017 including the specification, drawings and abstract is incorporated herein by reference in its entirety.

### BACKGROUND

### 1. Technical Field

The disclosure relates to a damper device.

### 2. Description of Related Art

Japanese Unexamined Patent Application Publication No. 4-321839 (JP 4-321839 A) discloses a technology relates to a mass body that is joined to a main body surface of a pulley via a rubber elastic body having a predetermined thickness and functions as a bending damper.

### SUMMARY

A bending damper is mounted on a rotary shaft member, for example, a crankshaft or the like of an internal combustion engine, and a mass body moves with the rotation of the crankshaft to attenuate vibration of the internal combustion engine. The bending damper effectively functions in a low rotation range or a medium rotation range of the internal combustion engine and effectively attenuates the vibration of the internal combustion engine. However, when the engine speed of the internal combustion engine enters a high rotation range, the noise, vibration (hereinafter referred to as “NV”) of a vehicle increases compared to the vibration of the internal combustion engine. When the bending damper continues to operate in the high rotation range of the internal combustion engine, the bending damper becomes a vibration source, and thus, rather, there is a possibility that the NV characteristic of the vehicle may deteriorate.

The disclosure provides a damper device that suppresses deterioration of an NV characteristic in a high rotation range of equipment on which a rotary shaft member is mounted.

An aspect of the disclosure relates to a damper device including a first damper and a behavior limiter. The first damper includes a base and a first mass body. The base is mounted on a rotary shaft member and configured to rotate together with the rotary shaft member, and the first mass body is provided on the base via a first elastic part. The behavior limiter is disposed around the first mass body on the outside in a rotation radial direction of the first mass body, and configured to limit a movement of the first mass body by coming into contact with the first mass body when a rotational frequency of the rotary shaft member has become equal to or higher than a threshold value.

The damper device may further include a buffer material that is interposed between the first mass body and the behavior limiter.

The damper device may further include a second damper having a second mass body. The second mass body may be provided on an outer periphery of a main body that is joined to the base via a second elastic part. The behavior limiter may be provided inside an accommodation portion that is provided at the main body and accommodates the first mass body.

With the above-mentioned damper device, it is possible to suppress deterioration of an NV characteristic in a high rotation range of equipment on which a rotary shaft member is mounted.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a perspective sectional view of a damper device of an embodiment;

FIG. 2 is a sectional view of the damper device of the embodiment;

FIG. 3 is a front view of a first damper that is included in the damper device of the embodiment;

FIG. 4 is a back view of the first damper that is included in the damper device of the embodiment;

FIG. 5 is a sectional view of the first damper of the embodiment taken along line V-V in FIG. 3;

FIG. 6 is a sectional view of the first damper of the embodiment taken along line VI-VI in FIG. 3;

FIG. 7 is a front view of a second damper that is included in the damper device of the embodiment;

FIG. 8 is a sectional view of the second damper of the embodiment taken along line VIII-VIII in FIG. 7;

FIG. 9 is an explanatory diagram showing a state where a first mass body of the first damper is in contact with a behavior limiter; and

FIG. 10 is a graph showing a change in a gap S between the first mass body of the first damper and the behavior limiter.

### DETAILED DESCRIPTION OF EMBODIMENTS

Hereinafter, an embodiment of the disclosure will be described with reference to the accompanying drawings. In the drawings, there is a case where the dimensions, the ratio, and the like of each part are not shown so as to completely coincide with the actual dimensions, ratio, and the like. Depending on the drawing, there is also a case where the drawing is drawn with details omitted.

### EMBODIMENT

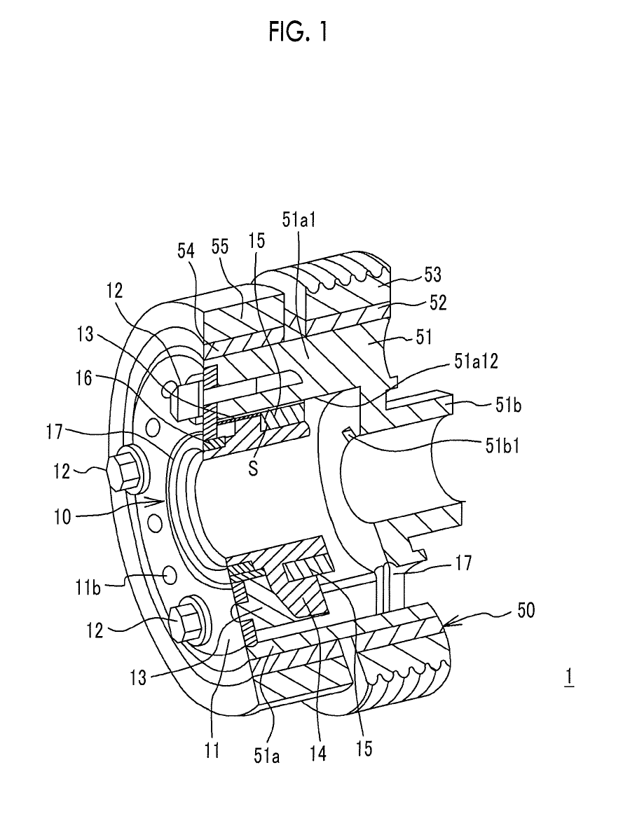

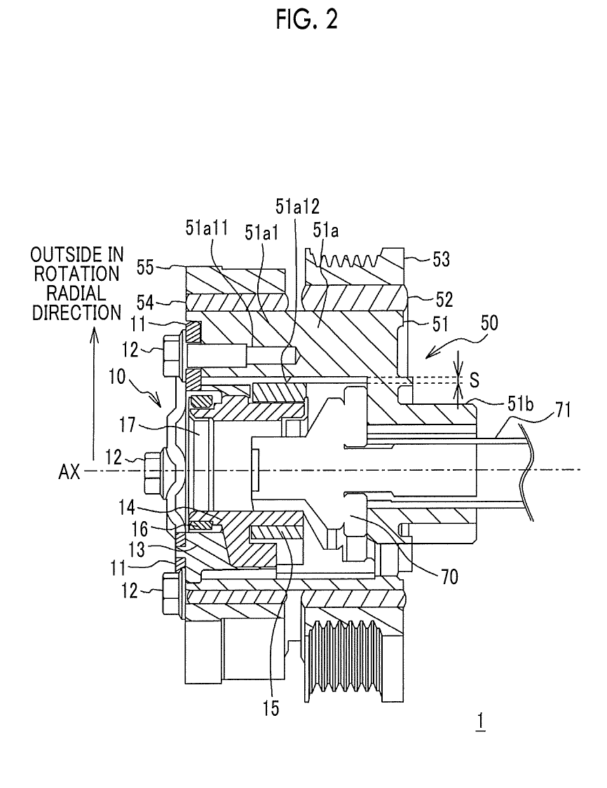

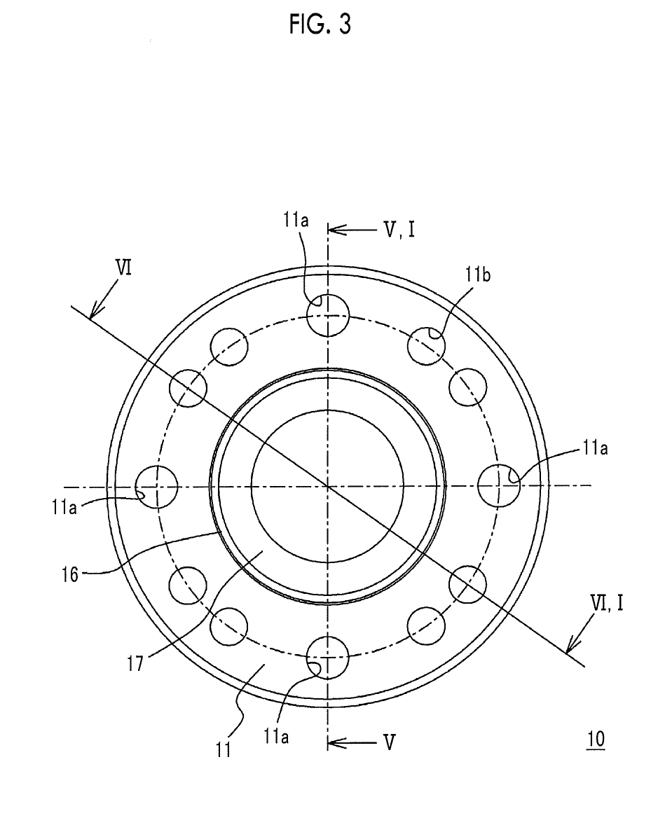

A schematic configuration of a damper device 1 of an embodiment will be described with reference to FIG. 1 and FIG. 2. FIG. 1 is a perspective sectional view of the damper device 1, and FIG. 2 is a sectional view of the damper device. However, the sections of FIG. 1 and FIG. 2 are sections taken along line I-I in FIG. 3 that shows a front view of a first damper 10.

The damper device 1 includes the first damper 10 and a second damper 50. The damper device 1 is mounted on a crankshaft 71 of an internal combustion engine, as shown in FIG. 2. The crankshaft 71 is an example of a rotary shaft member. Bending vibration and torsional vibration are generated in the crankshaft 71 according to a movement of a piston. The first damper 10 functions as a bending damper that suppresses mainly the bending vibration. The second damper 50 functions as a torsional damper that suppresses mainly the torsional vibration. The damper device 1 has, as the rotation center thereof, an axis that coincides with a center axis AX of the crankshaft 71. In the following description, a direction away from the center axis AX will be described as being the outside in a rotation radial direction.

The first damper 10 has a flange-like portion 11 serving as a base. The flange-like portion 11 is mounted on the crankshaft 71 via a main body 51 of the second damper 50 (described in detail later) and rotates together with the crankshaft 71. A first mass body 14 is provided at the flange-like portion 11 via a first elastic part 13. A first buffer part 15 is provided at the first mass body 14. The main body 51 of the second damper 50 has a first damper accommodation portion 51a that accommodates the first damper 10, and a behavior limiter 51a1 is provided in a part of the first damper accommodation portion 51a. The behavior limiter 51a1 is disposed around the first mass body 14 on the outside in the rotation radial direction of the first mass body 14. A gap S is formed between the first mass body 14 (the first buffer part 15) and the behavior limiter 51a1 in a state where the crankshaft 71 does not rotate. Due to the presence of the gap S between the first mass body 14 (the first buffer part 15) and the behavior limiter 51a1, the first mass body 14 moves according to the rotation of the crankshaft 71 and the first damper 10 functions as a bending damper.

The behavior limiter 51a1 limits a movement of the first mass body 14 by coming into contact with the first mass body 14 when the rotational frequency of the crankshaft 71 has become equal to or higher than a threshold value. When the rotational frequency of the crankshaft 71 increases, a centrifugal force acting on the first mass body 14 increases with an increase in the rotational frequency. When the centrifugal force acting on the first mass body 14 increases, a swing width of the first mass body 14 increases. Then, the first mass body 14 comes into contact with the behavior limiter 51a1, and finally, the movement of the first mass body 14 is limited. When the movement of the first mass body 14 is limited, an attenuation function of the first damper is reduced, and thus the damper device 1 avoids becoming a vibration source. In this way, deterioration of a noise, vibration (NV, hereinafter referred to as “NV”) characteristic in a high rotation range of equipment on which the crankshaft 71 is mounted, that is, an internal combustion engine, is suppressed.

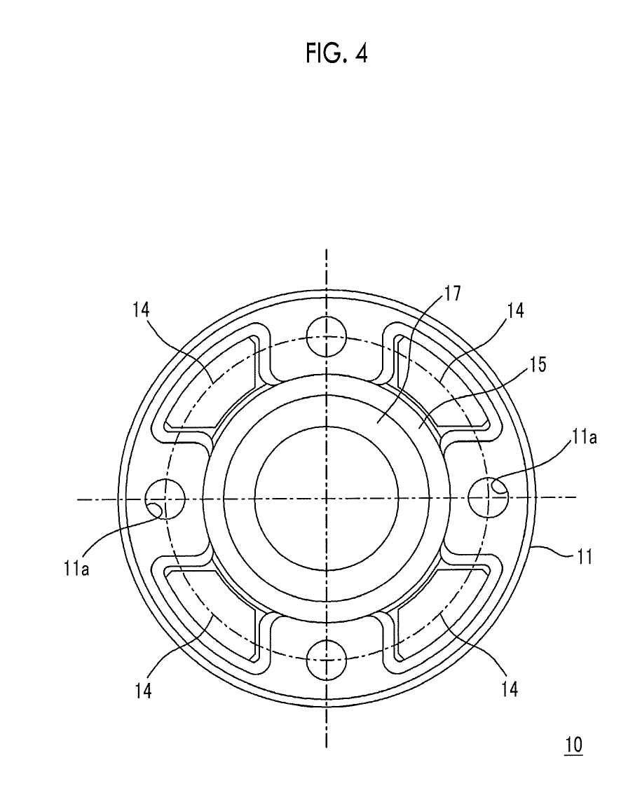

Here, the first damper 10 will be described in detail with reference to mainly FIG. 3 to FIG. 6. The flange-like portion 11 of the first damper 10 is a disk-shaped member and has four bolt holes 11a provided every 90°. A fastening bolt 12 shown in FIG. 1 and the like is inserted into each of the bolt holes 11a, and thus the flange-like portion 11 and the main body 51 of the second damper 50 are joined to each other. Two opening portions 11b are provided in the flange-like portion 11 between the bolt holes 11a. A rubber material forming the first elastic part 13 is poured into the opening portions 11b at the time of manufacturing the first damper 10. In the completed first damper 10, a state where the first elastic part 13 is exposed from the opening portions 11b is created.

The first damper 10 includes the first mass body 14 provided at the flange-like portion 11 via the first elastic part 13 formed of a rubber material as an example of an elastic material. The first mass body 14 in this embodiment is made of metal. The first elastic part 13 is interposed between the flange-like portion 11 and the first mass body 14, whereby the first mass body 14 can move with the rotation of the flange-like portion 11. The first mass body 14 moves with the rotation of the flange-like portion 11, thereby attenuating the vibration of the crankshaft 71.

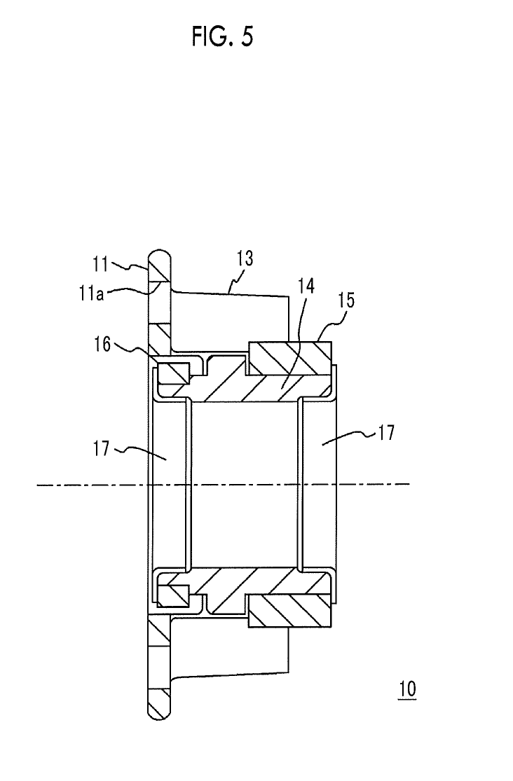

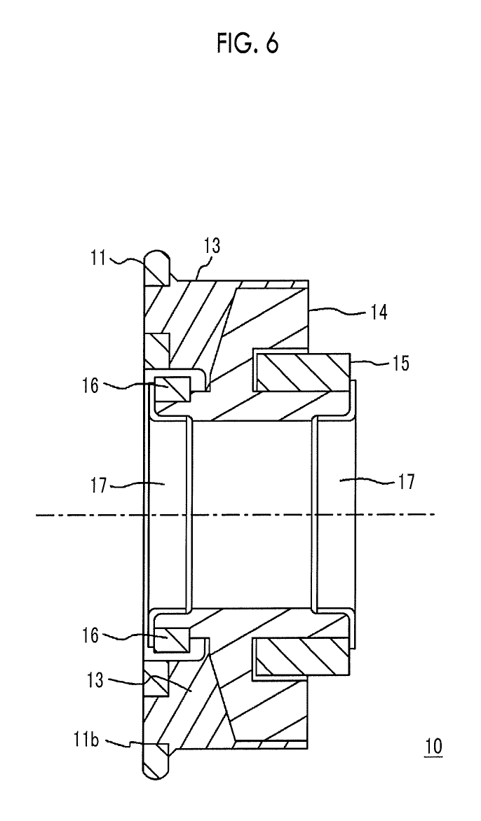

The first mass body 14 has an approximately tubular shape. However, the cross-sectional shape of the first mass body 14 varies according to a position at which a cross section is taken. For example, as shown in FIG. 5, in the cross section along line V-V in FIG. 3, the thickness of the cross section of the first mass body 14 is relatively thin, and as shown in FIG. 6, in the cross section along line VI-VI in FIG. 3, the cross section of the first mass body 14 is made to be thick in a radial direction. Portions having a cross section that is thick in the radial direction are provided at four locations between the bolt holes 11a. In this way, the mass distribution of the first mass body 14 is made uniform.

The first buffer part 15 having an annular shape is provided on the outer periphery of the first mass body 14 on the side away from the flange-like portion 11. The first buffer part 15 is formed of a resin member. The first buffer part 15 is interposed between the first mass body 14 and the behavior limiter 51a1, whereby the direct contact of the first mass body 14 with the behavior limiter 51a1 is avoided, and therefore, generation of abnormal noise is suppressed. Further, abrasion of the first mass body 14 or the behavior limiter 51a1 is suppressed. The first buffer part 15 of this embodiment is provided on the outer periphery of the first mass body 14. However, the first buffer part 15 may be provided on the behavior limiter 51a1 side. In short, it is favorable that a buffer material that is interposed between the first mass body 14 and the behavior limiter 51a1 is provided so as to be able to avoid the contact between metals.

A second buffer part 16 having an annular shape is also provided on the outer periphery of the first mass body 14 on the side close to the flange-like portion 11. The second buffer part 16 is formed of a resin member. The first mass body 14 has a tubular shape and is in a state of being supported on the first elastic part 13. For this reason, it is assumed that the first mass body 14 rotates in a state of being inclined with respect to the center axis AX. When the first mass body 14 is inclined, it is also assumed that a state where the side of the first mass body 14 close to the flange-like portion 11 comes into contact with the flange-like portion 11 is created. Also in the case described above, when the first mass body 14 comes into direct contact with the flange-like portion 11, generation of abnormal noise or abrasion is caused. Therefore, the second buffer part 16 is provided on the outer periphery of the first mass body 14 on the side close to the flange-like portion 11, whereby generation of abnormal noise or abrasion is suppressed.

A cap member 17 is mounted on each of the first buffer part 15 side and the second buffer part 16 side in the first mass body 14. The cap member 17 functions as a stopper for suppressing falling-off of the first buffer part 15 or the second buffer part 16.

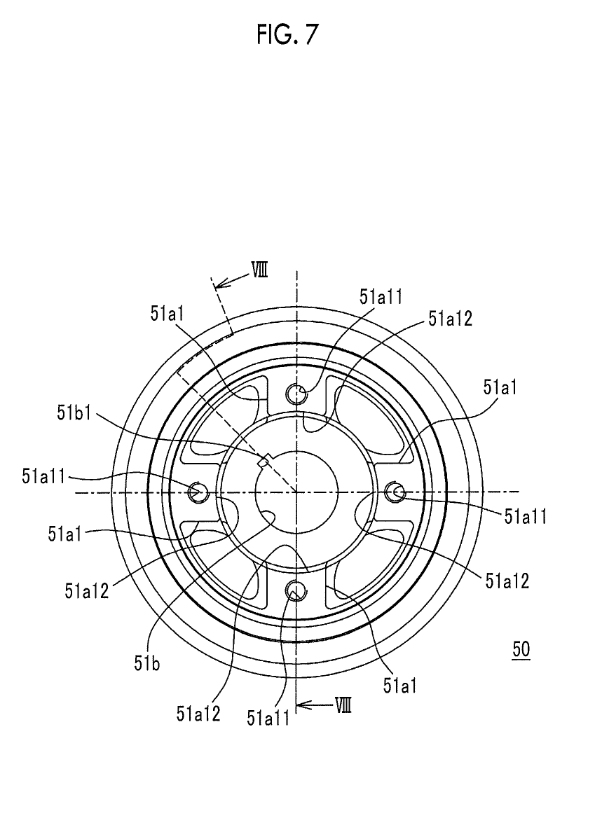

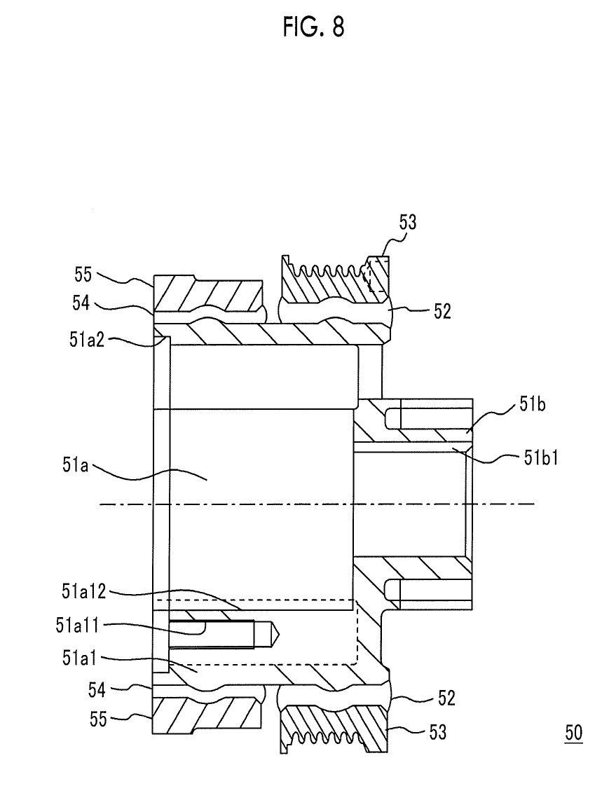

The second damper 50 will be described in detail with reference to mainly FIG. 7 and FIG. 8. The second damper 50 has the cylindrical main body 51 provided with the first damper accommodation portion 51a and a shaft mounting portion 51b provided continuously with the first damper accommodation portion 51a. The first damper accommodation portion 51a has a tubular shape and is provided with the behavior limiters 51a1 protruding inward at positions separated by 90°. In this embodiment, four behavior limiters 51a1 are provided. A bolt hole 51a11 is provided in each of the behavior limiters 51a1. When the flange-like portion 11 is mounted on the main body 51, the fastening bolt 12 is fastened to the bolt hole 51a11.

The first elastic part 13, the first mass body 14, and the first buffer part 15 of the first damper 10 are accommodated in a region surrounded by the four behavior limiters 51a1. In this way, the behavior limiters 51a1 are in a state of being disposed around the first mass body 14 on the outside in the rotation radial direction of the first mass body 14. The first mass body 14 and the first buffer part 15 are accommodated in the first damper accommodation portion 51a such that the gap S (refer to FIG. 2) is formed between each of the first mass body 14 and the first buffer part 15 and each of the behavior limiters 51a1 when being in a state where the crankshaft 71 does not rotate.

The inner peripheral surface of each behavior limiter 51a1 is a contact surface 51a12 that comes into contact with the first mass body 14 (the first buffer part 15) when the rotational frequency of the crankshaft 71 has become equal to or higher than a threshold value.

The behavior limiter 51a1 in this embodiment has an approximately rectangular shape. However, the shape of the behavior limiter 51a1 is not limited to a rectangular shape. The number of behavior limiters 51a1 in this embodiment is four. However, the number of behavior limiters 51a1 is also not limited to four. However, it is favorable that at least two behavior limiters 51a1 are provided, and it is favorable that the behavior limiters 51a1 are installed at equal intervals.

The shaft mounting portion 51b has a tubular shape, and a key groove 51b1 extending along the axial direction is provided on the inner peripheral surface of the shaft mounting portion 51b. A key provided on the crankshaft 71 side is inserted in the key groove 51b1. The main body 51 is fixed to the crankshaft 71 inserted into the shaft mounting portion 51b by fastening a shaft mounting bolt 70 (refer to FIG. 1 and FIG. 2).

A flange-like portion accommodation portion 51a2 formed in a recessed shape is provided at an end portion of the first damper accommodation portion 51a on the side opposite to the side on which the shaft mounting portion 51b is provided. The flange-like portion 11 is accommodated in the flange-like portion accommodation portion 51a2 in a state where the bolt hole 11a and the bolt hole 51a11 are aligned, and is integrated with the main body 51 by fastening the fastening bolt 12. In this way, the flange-like portion 11 can rotate together with the crankshaft 71. As described above, in the damper device 1 of this embodiment, the flange-like portion 11 can be removed from the main body 51. For this reason, firstly, the shaft mounting bolt 70 is fastened in a state where the flange-like portion 11 is removed from the main body 51, and thereafter, the flange-like portion 11 is mounted on the main body 51, whereby the damper device 1 can be easily mounted on the crankshaft 71.

A second mass body 53 is mounted on the outer periphery of the cylindrical main body 51 via a second elastic part 52 provided in an annular shape, and a third mass body 55 is further mounted on the outer periphery of the cylindrical main body 51 via a third elastic part 54 provided in an annular shape. In this way, the second damper 50 can function as a torsional damper. In this example, the second mass body 53 is used as a pulley for a timing belt.

In this embodiment, the main body 51 is equipped with the second mass body 53 or the third mass body 55, thereby forming the second damper 50, and the behavior limiter 51a1 is provided at the main body 51. In this way, the first damper 10 and the second damper 50 are integrally provided, and thus downsizing of the damper device 1 is attained. However, the behavior limiter 51a1 does not need to be necessarily provided integrally with the second damper 50, and may be provided separately from the second damper 50. In other words, it is not indispensable to mount the second mass body 53 or the third mass body 55 on the main body 51 provided with the behavior limiter 51a1.

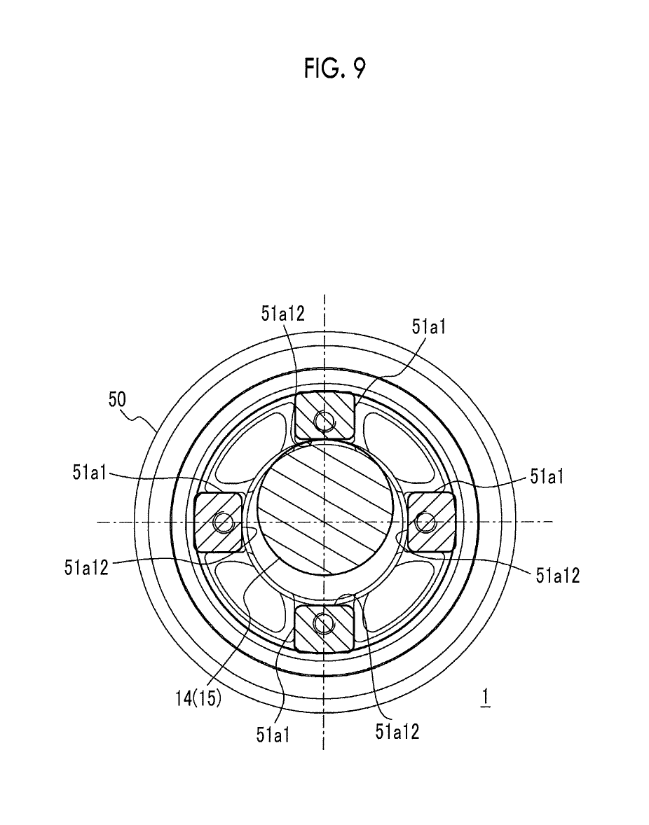

Hereinafter, the effect of the damper device 1 of this embodiment will be described with reference to FIG. 9. FIG. 9 shows a state where the first mass body 14 is in contact with the behavior limiter 51a1. The hatching in FIG. 9 is applied in order to easily distinguish the first mass body 14 and the behavior limiter 51a1 from other elements, and does not show the cross sections of the elements. When the crankshaft 71 on which the damper device 1 is mounted enters a high rotation state, the swing width of the first mass body 14 increases due to the centrifugal force, and, as shown in FIG. 9, the first mass body 14 comes in contact with any one of the behavior limiters 51a1, so that the movement of the first mass body 14 is limited. As a result of the limitation of the movement of the first mass body 14, the first damper 10 does not become a vibration source in the high rotation range of the internal combustion engine, and thus deterioration of the NV of a vehicle is suppressed.

A direction in which the first mass body 14 swings is affected by various factors such as variation in manufacturing of the first mass body 14 or the mounting state of the damper device 1 on the crankshaft 71. However, in the damper device 1 of this embodiment, due to the contact of the first mass body 14 with any one of the behavior limiters 51a1 in the high rotation range of the internal combustion engine, the movement of the first mass body 14 is limited. Due to the above, it is unnecessary to designate or manage the behavior limiter 51a1 with which the first mass body 14 comes into contact, among the four behavior limiters 51a1.

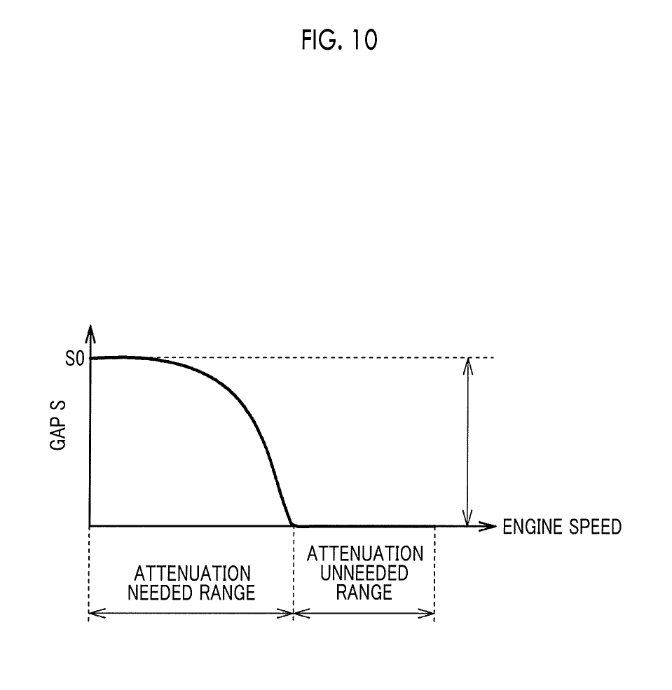

The first mass body 14 is set so as to come into contact with the behavior limiter 51a1 when the rotational frequency of the crankshaft 71 has become equal to or higher than a threshold value set in advance. Here, the threshold value is associated with an initial value S0 of the gap S between the first mass body 14 and the behavior limiter 51a1. Referring to FIG. 10, the gap S between the first mass body 14 (the first buffer part 15) and the behavior limiter 51a1 decreases as an engine speed, that is, the rotational frequency of the crankshaft 71 increases, and finally becomes zero. The threshold value is the engine speed that becomes the boundary between an attenuation needed range and an attenuation unneeded range. The initial value S0 is set such that the engine speed at which the gap S between the first mass body 14 (the first buffer part 15) and the behavior limiter 51a1 becomes zero becomes the boundary between the attenuation needed range and the attenuation unneeded range. The movement of the first mass body 14 is affected by the dimensions, the shape, and the mass of the first mass body 14, and further, the hardness, the shape, and the dimensions of the first elastic part 13, or the like. Due to the above, the initial value S0 is adjusted in consideration of the above factors as well. In a case where it is desired to set the attenuation unneeded range to a higher engine speed region, the initial value S0 may be set to be larger.

In the attenuation needed range, the first mass body 14 does not come into contact with the behavior limiter 51a1, and therefore, the damper device 1 can exhibit an attenuation function. In contrast, in a case where the engine speed increases and enters the attenuation unneeded range, the first mass body 14 comes into contact with the behavior limiter 51a1, so that the movement of the first mass body 14 is limited, and therefore, the first damper 10 does not become a vibration source and deterioration of the NV of the vehicle is suppressed. In a case where the engine speed decreases and returns to the attenuation needed range again, the damper device 1 returns to a state of being able to exhibit the attenuation function.

As described above, with the damper device 1 of this embodiment, deterioration of the NV characteristic in the high rotation range of the internal combustion engine on which the crankshaft 71 is mounted can be suppressed.

The above embodiment is merely an example for implementing the disclosure, and the disclosure is not limited to the embodiment. Various modifications of the embodiment are within the scope of the disclosure, and it is obvious from the above description that various other examples are possible within the scope of the disclosure.

What is claimed is:

1. A damper device comprising:
a first damper including a base and a first mass body, the base being mounted on a rotary shaft member and configured to rotate together with the rotary shaft member, and the first mass body being provided on the base via a first elastic part; and
a behavior limiter disposed around the first mass body on an outside in a rotation radial direction of the first mass body, the behavior limiter being configured to limit a movement of the first mass body by coming into contact with the first mass body when a rotational frequency of the rotary shaft member has become equal to or higher than a threshold value.

2. The damper device according to claim 1, further comprising a buffer material that is interposed between the first mass body and the behavior limiter.

3. The damper device according to claim 1, further comprising a second damper including a second mass body, the second mass body being provided on an outer periphery of a main body that is joined to the base via a second elastic part,
wherein the behavior limiter is provided inside an accommodation portion that is provided at the main body and accommodates the first mass body.
